(19) United States
(12) Patent Application Publication
(10) Pub. No.: US 2004/0196840 A1
(43) Pub. Date: Oct. 7, 2004

(54) Passive measurement platform

(76) Inventors: Bharadwaj Amrutur, Santa Clara, CA (US); Allan Liu, Oakland, CA (US); Alexander L. Tudor, Mountain View, CA (US); Richard W. Dugan, San Jose, CA (US)

Correspondence Address: AGILENT TECHNOLOGIES, Legal Department, DL429, Intellectual Property Administration, P.O. Box 7599, Loveland, CO, 80537-0599, US

(21) Appl. No.: 10/407,517

(22) Filed: Apr. 4, 2003

(51) Int. Cl. H04L 12/28

(52) U.S. Cl. 370/389

(57) ABSTRACT

The passive measurement platform may be incorporated into a network router or used in conjunction with a network router. The passive measurement platform receives an OSI data packet, extracts the OSI Layer 3 from the OSI data packet, extracts headers from the OSI Layer 3, generates a unique packet label corresponding to the headers, generates a timestamp, and creates a data packet that includes the headers, packet label, and timestamp. The timestamp is GPS-based to minimize problems associated with frequency drift and counter overflow. Both the push and pull models of data retrieval are used to conserve network bandwidth.

### BACKGROUND

The Internet's growth has found carriers adding capacity at an unprecedented rate. Tools to manage these networks have not been widely available or easily accessed.

As the importance of the IP networks increase along with their size, service assurance becomes critical. Today's solutions require bulky and expensive external probes that must be “bolted on” to equipment at selected network points. This is not scalable and is also taxing on power and space requirements. It is not an acceptable long-term solution.

The key service metrics of IP packet networks are packet loss, delay and jitter. Passive and active measurements may be used. Service providers' traffic engineering and capacity planning functions also need packet flow statistics.

Ennis, et al., in U.S. Pat. No. 5,521,907, “Method and Apparatus for Non-Intrusive Measurement of Round Trip Delay in Communications Networks”, measures the round-trip delay or travel in a communications network without taking the communications network out of service, and excluding variable delays imposed by protocol processing at the end points.

There are several drawbacks to the previously proposed solution. The timestamp is generated after the data stream has been analyzed and stored in memory. The analysis process and memory access takes a non-zero amount of time. In fact, the analysis time is unpredictable as it depends on the processing load on the processor. Thus, the resulting timestamp is inaccurate. Even without this unknown delay, the maximum accuracy of that solution is limited to 1 ms since the timestamps are generated using a 1 kHz signal. For multi-gigabit-per-second networks, 1 ms is a very long time and does not provide sufficient resolution to diagnose many network problems. As there are no provisions to prevent or detect counter overflow nor are the clocks in the two different probes synchronized, additional uncertainty is added to the measurement. Further, Ennis uses a client-server model of data retrieval or “pull model”. The console, which acts as the client, polls the probe, which acts as the server, for information. If the probe has information to send, the probe will transmit it; otherwise, the request is ignored. The “pull model” consumes valuable bandwidth on the network. Not all requests for data results in the actual transmission of data, since the requested data may not be available at the time of the request. Further, the method of adding up the bits in the data stream as 32-bit integers fails to generate, with high probability, unique signatures for different data packets. Yet another problem is that a separate network is required to transmit the data back to the console. Finally, Ennis cannot accurately determine a one-way delay calculation, which is a critical measurement in packet networks, such as the Internet.

### SUMMARY

The passive measurement platform may be incorporated into a network router/switch or used in conjunction with a network router/switch. The passive measurement platform receives an Open System Interconnect (OSI) data packet, extracts the OSI Layer 3 packet from the complete OSI data packet, extracts headers from the OSI Layer 3 packet, generates a unique packet label corresponding to the OSI Layer 3 packet, generates a timestamp, and creates a per packet records that includes the headers, packet label, and timestamp. The timestamp is derived from a GPS signal, or a source that can provide the same timing services and accuracy as the GPS signal, to minimize problems associated with frequency drift and synchronization. Both the push and pull models of data retrieval are used to conserve network bandwidth.

### BRIEF DESCRIPTION OF THE DRAWINGS

FIG. 1 illustrates a sample network.

FIG. 2 illustrates a block diagram of a port of the present invention.

FIG. 3 illustrates a functional block diagram according to the present invention.

FIG. 4 illustrates a functional block diagram of the header extractor 10 shown in FIG. 3.

FIG. 5 illustrates a functional block diagram of the packet processor 12 shown in FIG. 3.

FIG. 6 illustrates a functional block diagram of the timestamp generator 14 shown in FIG. 3.

FIG. 7 illustrates the transmission format of the measurement data.

FIG. 8 illustrates the internal interface processor 38 shown in FIG. 3.

FIG. 9 illustrates a process flowchart of the measurement platform shown in FIG. 3.

### DETAILED DESCRIPTION

The invention addresses the prior art limitations by delivering a highly capable measurement platform in an integrated circuit (IC). This IC solution can be used as an embedded device in interface cards of an equipment vendor's network element. By addressing the form factor issues of other traffic measurement solutions, the inventions arms carriers with a powerful and time-correlated view of how traffic is moving through their networks. This allows for a much more pervasive, full-time monitoring of the network without the need to modify equipment installations within the equipment room. Besides monitoring network health, this data will be increasingly important as a tool to allow carriers to provision service in an efficient, controlled, and verifiable manner.

The invention addresses five of the most critical pieces of information for network engineering and provisioning: network delay, network jitter, network loss, flows, and network utilization.

This present solution provides a very high degree of accuracy, within ˜500 ns. In this illustrative example, the accuracy is within ˜200 ns. This is achieved by eliminating the delay in generating the timestamp (as done by Ennis) and also in using a global positioning system (GPS) receiver to provide a highly accurate clock source; alternatively, other sources that can provide the same timing services and accuracy as the GPS signals can also be used. This eliminates the problems of frequency drift and counter overflow.

The invention uses the push and pull models of data retrieval. When in the push model, the server signals to the client that data is available for retrieval. The client can then instruct the server to send the data; alternatively, the server can be configured to transmit the data to the client automatically whenever the server has data to transmit. This eliminates the need for the client to periodically poll the server for data. Bandwidth on the network is conserved. If this functionality is not desired, a pull model of data retrieval can be employed. In this model, the client will send requests for data from the server whenever the client needs that information; there is no guarantee that what the client is requesting is available. Since a request needs to be transmitted and not all requests result in data being transmitted from the server to the client, this model consumes more network bandwidth.

Cyclic redundancy check (CRC) algorithms are used to generate a unique packet identifier. The packet ID is 32 bits. The probability of a duplicate signature is much lower than that in the prior art (Ennis).

The invention is a basic network element and eliminates the need for a separate network for data transmission as shown in the prior art (Ennis). There is also a significant power and physical space savings as a result.

The present invention makes five measurements: network delay, network jitter, packet loss, flow, and network utilization. Additional data may be included in the transmitted measurement data to allow the users to extract additional revenue from their infrastructure.

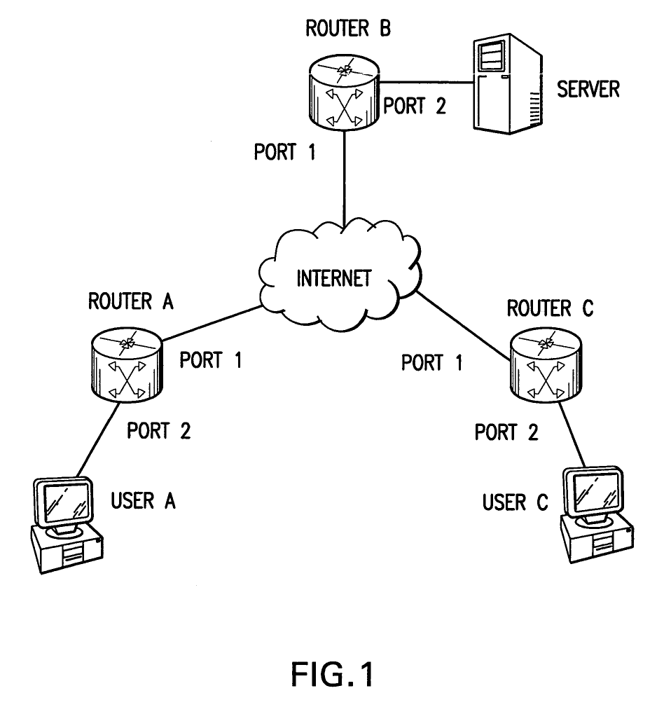

FIG. 1 illustrates a sample network using routers equipped with the passive measurement platform. Each of the edge routers, Router A, Router B, and Router C, connect users on a local area network (LAN) onto the Internet. Router A connects to User A while Router C connects to User C. Router B is connected to a server.

When User A makes a telephone call via the Internet to User C, it is desirable to have the one-way delay be less than 150 ms as defined in ITU-TG.114. The perception of interactive conversation degrades as the delay increases beyond 150 ms. Additionally, network jitter affects the perceived quality of the conversation. Network jitter is the variation in the arrival time of the data packets. Another critical parameter is packet loss. Periodic loss in excess of 5-10% of all voice packets transmitted can degrade voice quality significantly. Occasional bursts of packet loss can also make conversation difficult.

In the telephone call between Users A and C, data packets flow to and from each of the users. At Router A and Router C, a timestamp, unique packet identifier (ID), and other packet header information are stored for each packet. This data is stored and transmitted via one of the ports on the routers to the Server for further analysis. With the data, a network engineer can monitor all the critical parameters of a telephone call via the Internet. And the network engineer will have real time information on the health of the network.

The Open System Interconnection (OSI) model defines a networking framework for implementing protocols in seven layers. Control is passed from one layer to the next, starting at the application layer in one station, proceeding to the bottom layer, over the channel to the next station and back up the hierarchy.

OSI Layer 7 supports application and end-user processes. Communication partners are identified, quality of service is identified, user authentication and privacy are considered, and any constraints on data syntax are identified. Everything at this layer is application-specific. This layer provides application services for file transfers, e-mail, and other network software services. Telnet and FTP are applications that exist entirely in the application level. Tiered application architectures are part of this layer.

OSI Layer 6 provides independence from differences in data representation (e.g., encryption) by translating from application to network format, and vice versa. The presentation layer works to transform data into the form that the application layer can accept. This layer formats and encrypts data to be sent across a network, providing freedom from compatibility problems. It is sometimes called the syntax layer.

OSI Layer 5 establishes, manages and terminates connections between applications. The session layer sets up, coordinates, and terminates conversations, exchanges, and dialogues between the applications at each end. It deals with session and connection coordination.

OSI Layer 4 provides transparent transfer of data between end systems, or hosts, and is responsible for end-to-end error recovery and flow control. It ensures complete data transfer.

OSI Layer 3 provides switching and routing technologies, creating logical paths, known as virtual circuits, for transmitting data from node to node. Routing and forwarding are functions of this layer, as well as addressing, internetworking, error handling, congestion control and packet sequencing.

At OSI Layer 2, data packets are encoded and decoded into bits. It furnishes transmission protocol knowledge and management and handles errors in the physical layer, flow control and frame synchronization. The data link layer is divided into two sublayers: The Media Access Control (MAC) layer and the Logical Link Control (LLC) layer. The MAC sublayer controls how a computer on the network gains access to the data and permission to transmit it. The LLC layer controls frame synchronization, flow control and error checking.

OSI Layer 1 conveys the bit stream—electrical impulse, light or radio signal—through the network at the electrical and mechanical level. It provides the hardware means of sending and receiving data on a carrier, including defining cables, cards and physical aspects. Fast Ethernet, RS232, and ATM are protocols with physical layer components.

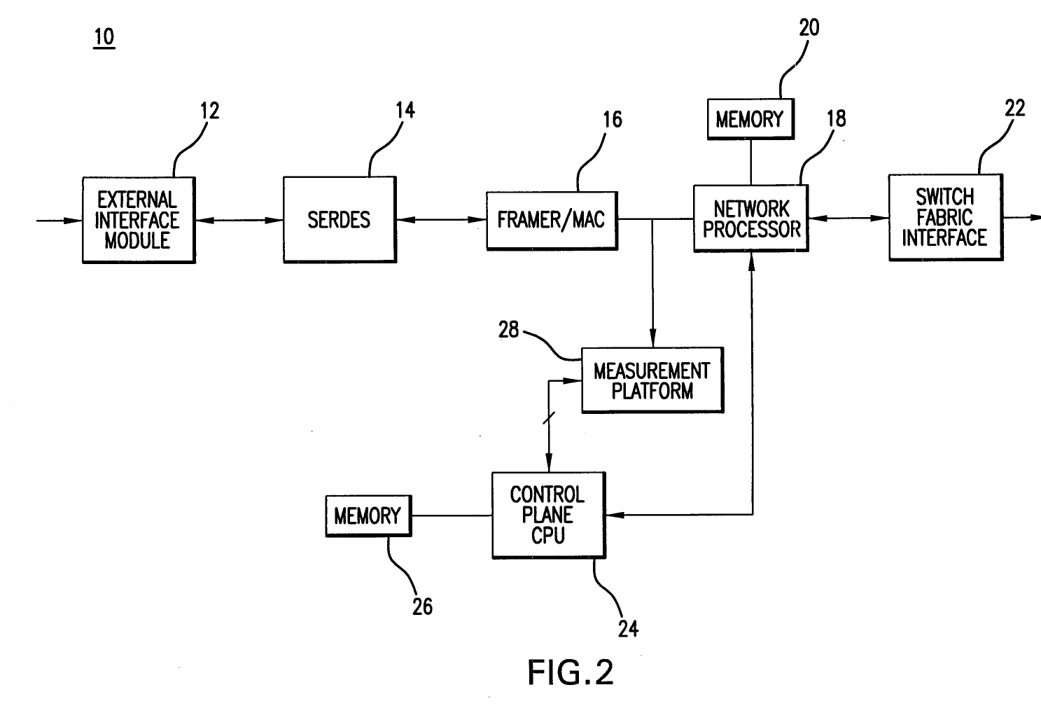

FIG. 2 illustrates a block diagram (10) of a router/switch port equipped with the present invention. An External Interface Module (12) connects the port to the outside world; an example of such a module is a 10 Gigabit Ethernet XENPAK optical module. The External Interface Module (12) further connects to a serializer-deserializer (SerDes) (14). The framer/MAC (16) performs an OSI Layer 2 operation on data received by the SerDes (14). A network processor (18) performs packet classification and other routing related functions. The network processor (18), having its own associated memory (20), further connects to a switch fabric interface (22) that connects this port to other ports within the same router/switch. A control plane central processing unit (CPU) (24), having its own associated memory (26), communicates bidirectionally with the network processor (18). The control plane CPU (24) performs management functions, e.g. port configuration, calculation of the routing table, etc. The partitioning of these functions varies with implementations. In this embodiment, a measurement platform (28) connects between the Framer/MAC (16), control plane CPU (24), and network processor (18). The measurement platform (28) may receive data from any connection point before the network processor (18), e.g. between the External Interface Module (12) and the SerDes module (14), between the SerDes module (14) and the Framer/MAC (16), or between the Framer/MAC (16) and the Network Processor (18). Alternatively, the measurement platform (28) may receive data directly or be embedded inside each of the blocks: optical module (12), SerDes (14), Framer/MAC (16), or Network Processor (18).

The measurement platform (28) must gain access to the data before or at the same time as the network processor (18). The integration of the measurement platform (28) into the port (10) saves both power and physical space.

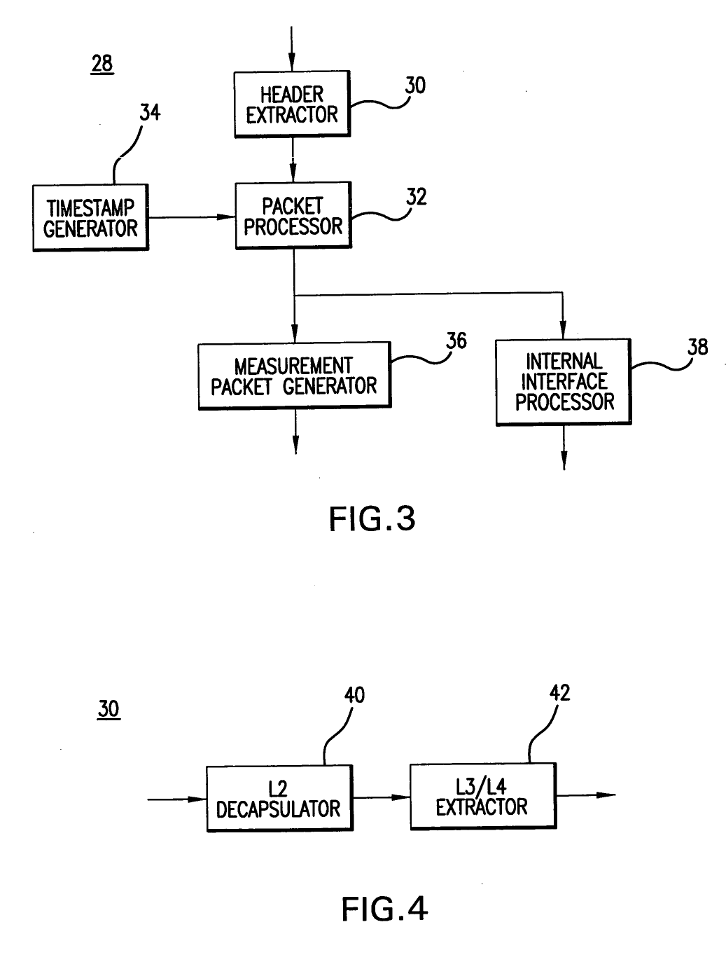

FIG. 3 illustrates a functional block diagram of the measurement platform (28) shown in FIG. 2. A header extractor (30) is connected to a packet processor (32). A timestamp generator (34) provides input to the packet processor (32). The packet processor (32) generates the inputs for a measurement packet generator (36) and an internal interface processor (38). This may be implemented as dedicated logic circuitry or in a microprocessor.

FIG. 4 illustrates a functional block diagram of the header extractor (30) shown in FIG. 3. A Layer 2 decapsulator (40) is connected to a Layer 3/Layer 4 extractor (42).

The Layer 2 decapsulator (40) removes the OSI Layer 2 encapsulation from the data packet to extract the OSI Layer 3 packet.

The Layer 3/Layer 4 extractor (42) extracts the relevant OSI Layer 3 and OSI Layer 4 headers depending upon the configuration. If multi-protocol label switching (MPLS) is configured, then it can optionally extract the MPLS label. The output of this block is the septuple <Flow (3), IP src (4/16), IP des (4/16), Tos (1), Protocol (1), Src port (2), Dst port (2)>. For IPv4, there are 17 bytes. For IPv6, there are 41 bytes. The flow label may be the MPLS label or a Frame Relay ID or asynchronous transfer mode virtual path identifier/virtual circuit identifier (ATM VPI/VCI) or a label generated based on the TCP/IP header information.

In the present invention, the layer 3 and layer 4 headers may be extracted individually or in combination.

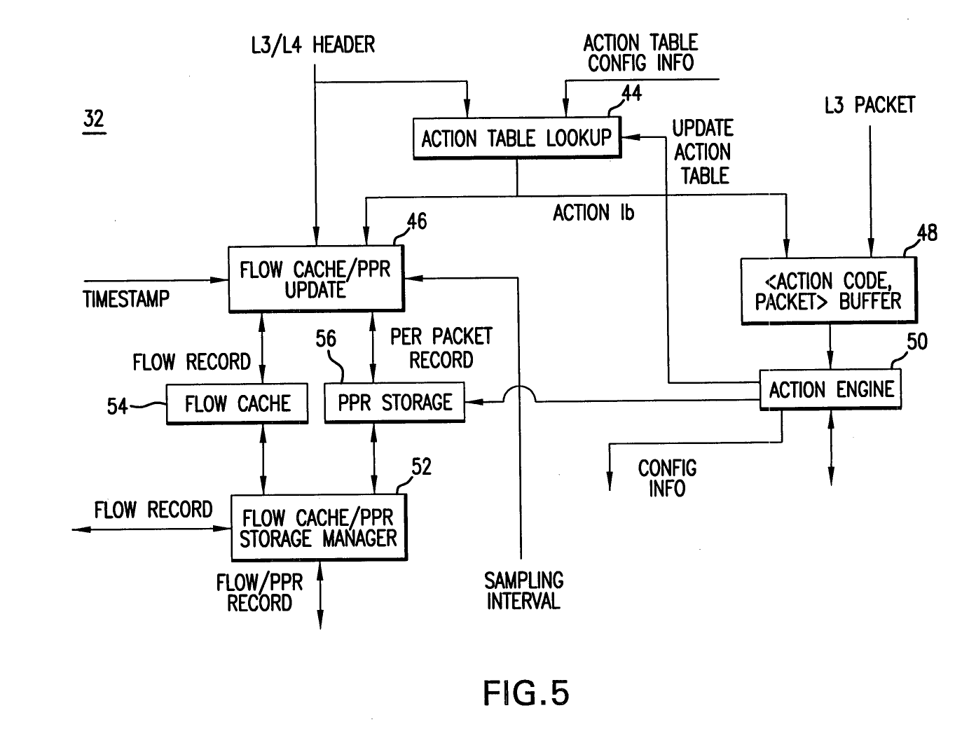

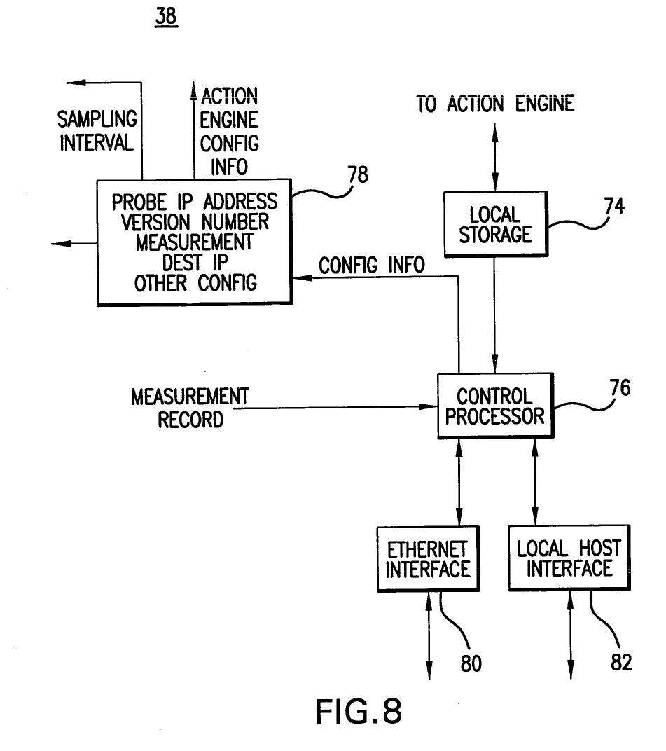

FIG. 5 illustrates a functional block diagram of the packet processor (32) shown in FIG. 3. It can be programmed to: (a) compute and export flow counts, (b) perform elementary filtering with timestamping, (c) emit configurable thresholding events to the monitoring station. An action table lookup (44), receives external input, is connected to a Flow Cache/Per Packet Record (PPR) update module (46) and an Action Code packet buffer (48). The action table lookup (44) is programmed to generate action identifiers to be interpreted by (46) and (48) when the input meets the filtering criteria set by the action engine (50), as received by it from the internal interface module (FIG. 8). The filtered packets are time-stamped by Flow/PPR update (46) and stored in (56). PPR storage records are periodically pushed to the monitoring station. Flow records may or may not be subject to filtering action. Thresholding events are handled by the action engine (50). The action engine (50) connects to both the action table lookup (44) and the Action code packet buffer (48). Flow Cache/PPR storage manager (52) manages the flow cache (54) and the PPR Storage (56), both connected to the Flow Cache/PPR manager (46).

The action engine (50) is a general-purpose microprocessor core, e.g. 16/32-bit embedded RISC microprocessor with a dedicated instruction memory. The actions are stored in the instruction memory and operate on the captured packets or data stored in the PPR Storage (56).

The cache manager (46) maintains the flow records in a set associative cache. Each flow cache entry is 64 bytes long and consists of a status byte and the flow record. The status byte may have 2 bits: valid and lock. If the valid bit is set, the cache entry is valid. If the lock bit is set, the cache manager cannot delete the cache entry. Although this embodiment illustratively shows a flow cache entry of 64 bytes, the size of the flow cache entry depends upon the overall implementation of the present invention.

A flow record, stored in flow cache (54), contains the flow header and the flow data. The flow header consists of the tuple <flow label (3), IP src (4/16), IP dst (4/16), Tos (1), Protocol (1), Src port (2), Dst port (2)>. A flow is uniquely identified by either the flow label or the tuple <IP src, IP dest, protocol, tos, src port, dest port>. The tuple may be configured. The flow data portion contacts the tuples <packet count (4), byte count (4), start timestamp (4), latest timestamp (4), others (30/6)>, for a total of 46 bytes for IPv4 and 22 bytes of IPv6. For the fields labeled other, the data stored is configurable per flow and is determined by the <STATS, function_ptr> obtained from the action lookup table. Together with the flow header of 17/41 bytes, the flow record size is 63 bytes.

The per packet record (PPR) storage unit (56) stores any data that is per packet, e.g. timestamps. Flows that need timestamps recorded per packet will have a pointer in the flow record, which will point to the PPR list data structure. The PPR may store only samples to conserve memory. In this embodiment, the PPR size is 1 Mbyte and the PPR record size is 6 bytes: 4 bytes for the packet ID and 2 bytes for the incremental time stamps. This will allow storage for approximately 170,000 timestamps. To further illustrate, a voice conversation lasts about 5 minutes. Each voice call will generate a packet once every 20 ms for a total of 15K packets per call. Assuming a sampling rate of 1 in 100, 150 records per voice call implies that timestamp records for up to 1000 voice calls may be stored.

The flow cache/PPR storage manager (52) walks through every entry of the flow cache, at regular intervals to determine which flow entries are old enough to be removed from the cache. It uses an inactivity timer and an activity timer. Both timers are user-configurable.

The action lookup table (44) contains a list of measurement actions that can be executed beyond the default actions of keeping packet and byte count statistics. These actions are applicable to broad classes of flows, e.g. TCP, RTP, or specific type of service bits, etc. Actions can also be defined for MPLS-type tunnels that can be easily identified by the flow label. An example for such a flow could be all packets traveling through a certain point of a network that have identical source and destination IP network addresses.

The action lookup table (44) may be implemented by a small content addressable memory (CAM). The action table is indexed by a configurable combination of the flow label, type of service, source and destination port ids of the header fields. The output is an action identifier that is interpreted by both the flow cache update unit and the action engine. The list of actions may include, but are not limited to:

<EXECUTE, function_ptr>: the action engine is to grab the entire packet and apply the function pointed to by function_ptr

<STATS, function_ptr>: the flow update unit is to compute special statistics indicated by the function pointed to by function_ptr

The <Action code, packet> buffer (48) is buffer that stores the output of the Action Table Lookup (44) and the layer 2 Decapsulator (40) until the Action Engine (50) is ready to accept the data.

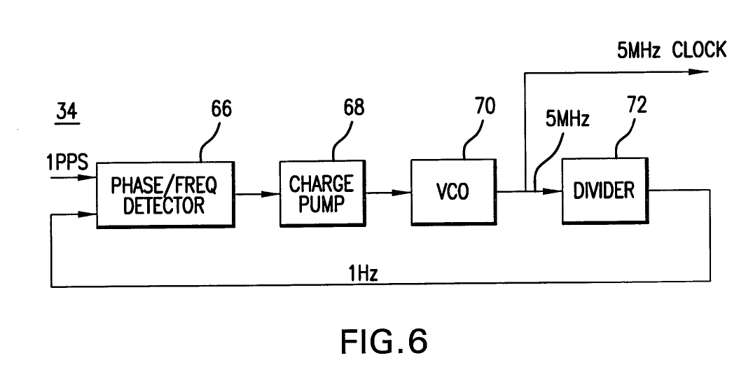

FIG. 6 illustrates a functional block diagram of the timestamp generator (34) shown in FIG. 3. The timestamp generator may be a phase lock loop (PLL). A phase/frequency detector (66) receives a 1 PPS (pulse per second) from a GPS derived signal. Note that an implementation that uses a source that can provide the same timing services and accuracy as the GPS signal is also valid. A charge pump (68) interposes the phase/frequency detector (66) and a voltage controlled oscillator (VCO) (70). The VCO (70) generates a 5 MHz clock signal that is synchronized to the 1 PPS signal. A divider (72) divides the 5 MHz clock and generates a 1 Hz signal for comparison with the 1 PPS signal by the phase/frequency detector (66) to determine if the VCO is synchronized or not.

The timestamp generator (34) generates an absolute timestamp derived from a GPS signal, or a source that can provide the same timing services and accuracy as the GPS signal. This information is used to provide accurate timestamp data for measurements, e.g. network delay or network jitter.

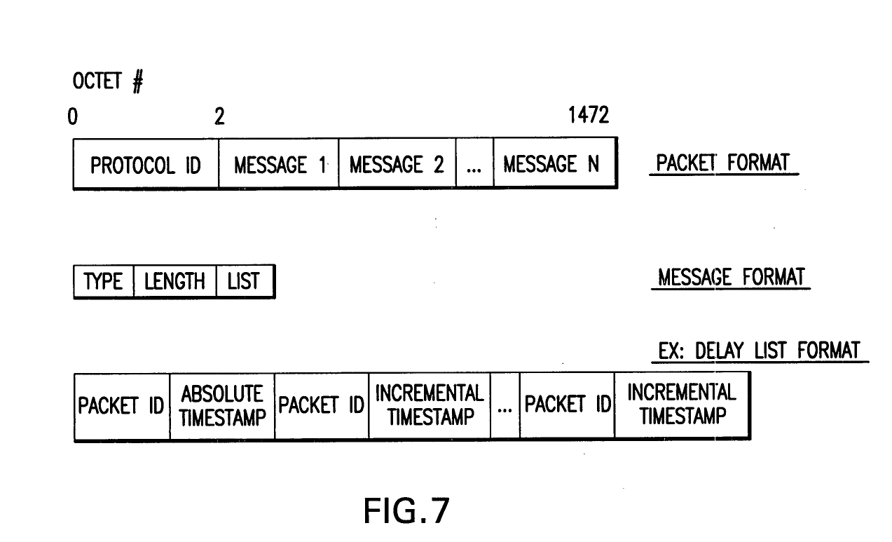

FIG. 7 illustrates an example of the transmission format of the measurement data generated by measurement packet generator (36). In this example, the packet is assembled into a UDP or TCP packet. The list format depends upon the measurement being made. Protocol ID is used to provide for future versions of this probe as well as possible expansions. The receiver of the packet can process the packet depending on the protocol ID. Type refers to the type of measurement data. Length refers to the length, in bytes, of the message. Packet ID refers to the packet ID generated by the packet ID generation unit.

FIG. 8 illustrates the internal interface processor 38 shown in FIG. 3. A local storage unit (74) communicates with the Action Engine (50). A control processor (76) stores configuration data in configuration memory (78) and directs the flow of measurement data out of and the flow of configuration data into the measurement platform (28). The control processor (76) further connects with Ethernet interface (80) and local host interface (82).

The control processor (76) is a standard microprocessor core, e.g. 16/32-bit embedded RISC microprocessor. It manages the interaction of the probe with the external world, via the Ethernet interface (80) and/or the local host interface (82).

The Ethernet interface (80) can be used to interface with an external measurement box to download data collected by this chip for in-depth analysis. Alternatively, it can be used to configure the IC.

The local host interface (82) may be used for configuration and to upload data to an analysis station.

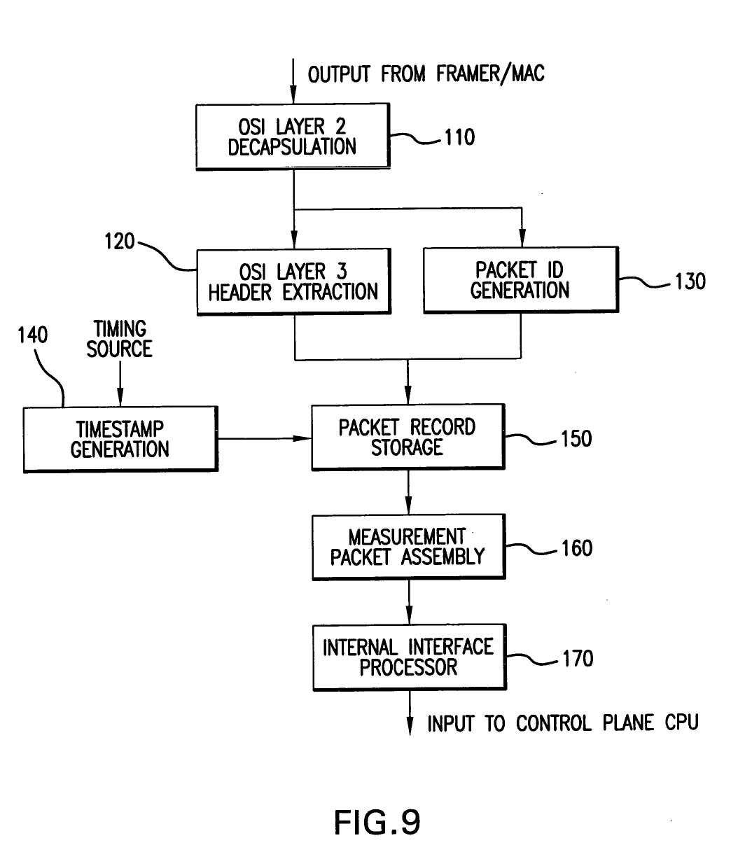

FIG. 9 illustrates a process flowchart of the measurement platform (28) shown in FIG. 3.

In step 110, the Layer 2 decapsulator removes the Layer 2 headers to extract the OSI Layer 3 packet from the output of the Framer/MAC.

In step 120, the headers are extracted from the OSI Layer 3 packet. In this embodiment, the OSI Layer 3 packet is an IP packet. The outputs of this step are the IP headers defined in RFC 791: IP version number, header length, type of service, length of packet, identification, flags, fragment offset, time to live, protocol, header checksum, source IP address, and destination IP address.

In step 130, a packet ID is generated. The packet ID is used in conjunction with other parameters to uniquely identify the packet. The 32-bit packet ID is generated by executing the CRC algorithm on the first 512 bytes or the entire data portion of the IP packet, whichever is less. The CRC algorithm can be found in any textbook on coding algorithms or digital logic. The generator polynomial is shown below:

G(x)=X³²+X²⁶+X²³+X²²+X¹⁶+X¹²+X¹¹+X¹⁰+X⁸+X⁷+X⁵+X⁴+X³+X²+X¹+1 Equation 1

The packet ID is calculated over the first 512 bytes to limit data fragmentation as it travels from the source to the destination. If fragmentation occurred, the packet ID computed at and after the point of fragmentation would be changed and there would be no way to correlate the data collected before and after the fragmentation.

In step 140, the timestamp is derived from a GPS signal, or a source that can provide the same timing services and accuracy as the GPS signal. The receiver outputs a 1 pulse per second (1 PPS) signal that is synchronized to the GPS atomic clocks or a similar source. In addition, the receiver must output time and date information; the time information is accurate to 1 second. The 1 PPS signal will be used to generate the sub-second timing information. The first set of outputs from this block will be 40 bits: 5 bits to represent the hour, 6 bits to represent the minute, 6 bits to represent the second, and 23 bits to represent the sub-second information. The GPS receiver or a similar source provides the hour, minute, and second information. The 23-bit sub-second data is generated by the PLL. This data represents the absolute time, accurate to 200 ns, at which a packet is received.

The second set of output from this module will be 24 bits and an overflow bit. This corresponds to the inter-arrival time of consecutive packets. The 24 bits will come from the content of a 24-bit counter clocked by the 5 MHz clock. The overflow bit is high if the counter overflowed or rolled-over. It remains high until cleared. To generate a valid set of outputs (24-bit counter value and an overflow bit), a reset signal is required. The reset signal resets the counter to zero as well as clears the overflow bit. The content of the counter is read after the last bit of the packet is received. The timing of the circuitry is such that after the last bit has been received and after the counter has been read, the counter is reset to zero. The contents of the counter represent the time elapsed from the end of one packet to the end of another packet or the inter-arrival time of the packets.

In step 150, the IP header information, the packet ID, and the timestamp are stored. The data comprises the packet record. The IP header information may be user configured. Either the absolute timestamp or the inter-arrival time of packets may be selected. The absolute timestamp is stored when one of the following conditions is met: 1) the 24 bit counter used to record inter-arrival time of consecutive packets overflowed or 2) the number of packet records in memory equals or exceeds a threshold number. Otherwise, the inter-arrival timestamp is stored. The inter-arrival timestamp conserves memory. For a set of packet records, the absolute time of arrival can be derived from a single absolute timestamp and a set of inter-arrival timestamps.

In step 160, the data is collected and transmitted to a user configurable destination. The packet will be assembled into a UDP or TCP packet and sent to the analysis station over the IP network. The analysis station knows the origin of the measurement data by examining the source IP address in the IP header.

In step 170, the internal interface processor provides this data to external devices.

We claim:

1. A router/switch comprising:
an External Interface Module for transceiving data;
a framer/MAC connected to External Interface Module;
a network processor and network memory, the network processor connected to the framer/MAC and memory;
a control plane CPU and control plane memory, connected bidirectionally with the network processor; and
a measurement analyzer connected to one of the transceiving data port and framer/Mac.

2. A router/switch as defined in claim 1, wherein the measurement analyzer comprising:
a header extractor, receiving an OSI data packet, outputting OSI Layer 3/4 data;
a packet processor, receiving the OSI Layer 3/4 data, outputting headers and a packet label;
a timestamp generator recording the receipt of the OSI data packet and generating a timestamp having an accuracy comparable to GPS; and
a measurement packet generator, receiving the headers, packet label, and timestamp, generating a measurement data packet.

3. A measurement analyzer as defined in claim 2, wherein the timestamp generator includes a phase lock loop.

4. A measurement analyzer as defined in claim 3, wherein the phase lock loop generates an absolute timestamp.

5. A measurement analyzer as defined in claim 3, wherein the phase lock loop generates an inter-arrival timestamp.

6. A measurement analyzer as defined in claim 2, wherein the timestamp is within 500 nanoseconds of absolute time.

7. A measurement analyzer as defined in claim 2, the header extractor including:
an OSI Layer 2 decapsulator that extracts the OSI Layer 3 packet from the OSI data packet; and
a Layer 3/Layer4 extractor, receiving the OSI Layer 3 packet, outputting headers corresponding to the OSI Layer 3/4 packet.

8. A measurement analyzer as defined in claim 2, wherein the packet label is generated using a cyclical redundancy check algorithm.

9. A measurement analyzer comprising:
a header extractor, receiving an OSI data packet, outputting OSI Layer 3/4 data;
a packet processor, receiving the OSI Layer 3/4 data, outputting headers and a packet label;
a timestamp generator recording the receipt of the OSI data packet and generating a timestamp having an accuracy comparable to GPS; and
a measurement packet generator, receiving the headers, packet label, and timestamp, generating a measurement data packet.

10. A measurement analyzer as defined in claim 9, wherein the timestamp generator includes a phase lock loop.

11. A measurement analyzer as defined in claim 10, wherein the phase lock loop generates an absolute timestamp.

12. A measurement analyzer as defined in claim 10, wherein the phase lock loop generates an inter-arrival timestamp.

13. A measurement analyzer as defined in claim 9, wherein the timestamp is within 500 nanoseconds of absolute time.

14. A measurement analyzer as defined in claim 9, the header extractor including:
an OSI Layer 2 decapsulator that extracts the OSI Layer 3 packet from the OSI data packet; and
a Layer 3/Layer4 extractor, receiving the OSI Layer 3 packet, outputting headers corresponding to the OSI Layer 3/4 packet.

15. A measurement analyzer as defined in claim 9, wherein the packet label is generated using a cyclical redundancy check algorithm.

16. A method for network analysis comprising:
receiving an OSI data packet;
extracting the OSI Layer 3 from the OSI data packet;
extracting headers from the OSI layer 3/4;
generating a packet label corresponding to the headers;
generating a timestamp having an accuracy comparable to GPS; and
creating a data packet that includes the headers, packet label, and timestamp.

17. A method as defined in claim 16, wherein generating a timestamp includes generating an absolute timestamp.

18. A method as defined in claim 16, wherein generating a timestamp includes generating inter-arrival timestamps.

19. A method as defined in claim 16, wherein receiving an OSI data packet includes a server signaling to a client that data is available for retrieval.

20. A method as defined in claim 16, wherein receiving an OSI data packet includes a server transmitting data to a client automatically.

21. A method as defined in claim 16, wherein creating the data packet includes generating the packet label using a cyclical redundancy check algorithm.
